(19) United States
(12) Patent Application Publication
(10) Pub. No.: US 2019/0011692 A1
(43) Pub. Date: Jan. 10, 2019

(54) ROTARY DRIVE APPARATUS

(71) Applicant: Nidec Corporation, Kyoto (JP)

(72) Inventor: Junya MIZUKAMI, Kyoto (JP)

(21) Appl. No.: 15/725,381

(22) Filed: Oct. 5, 2017

(30) Foreign Application Priority Data
Jul. 10, 2017 (JP) 2017-134861

(51) Int. Cl. G02B 26/08; G02B 7/02; H02K 7/02; H02K 7/14

(52) U.S. Cl. CPC G02B 26/0816; G02B 7/025; H02K 7/14; H02K 7/02; G02B 26/0875

(57) ABSTRACT

This rotary drive apparatus is arranged to cause incoming light coming from a light source to be reflected, and rotate resulting reflected light, and includes a motor including a rotating portion arranged to rotate about a central axis extending in a vertical direction; and a flywheel supported by the rotating portion, and caused by the rotating portion to rotate about the central axis. The flywheel includes a lens arranged to allow the reflected light to pass therethrough; a lens frame arranged to be in contact with at least a portion of a peripheral portion of the lens; and a main body arranged to support the lens or the lens frame. The main body includes an outer cylindrical portion arranged to define at least a portion of an outer circumferential surface of the main body, and an accommodating portion in which the lens frame is arranged. At least a portion of the lens frame and at least a portion of the main body are arranged to have a first adhesion portion therebetween. At least a portion of the lens is arranged radially between the main body and the lens frame.

### CROSS REFERENCE TO RELATED APPLICATIONS

This application claims the benefit of priority to Japanese Patent Application No. 2017-134861 filed on Jul. 10, 2017. The entire contents of this application are hereby incorporated herein by reference.

### BACKGROUND OF THE INVENTION

### 1. Field of the Invention

The present invention relates to a rotary drive apparatus.

### 2. Description of the Related Art

A known scanner apparatus used for position recognition in a head-mounted display (HMD) or the like typically has installed therein a mirror arranged to reflect incoming light coming from a light source, and a lens arranged to allow reflected light to pass therethrough. A known apparatus including an optical component, such as, for example, a lens, is described in, for example, JP-A 10-282385.

In the known apparatus described in JP-A 10-282385, a retaining ring arranged to support the optical component is engaged with a fixing frame including an opening in which the optical component of the apparatus can be fitted, and this arrangement makes it easy to detachably fix the optical component to the apparatus. However, damage of any member that is involved in the above engagement due to aging, for example, might cause the optical component to be detached from the apparatus and come off or fly away.

### SUMMARY OF THE INVENTION

A rotary drive apparatus according to a preferred embodiment of the present invention is arranged to cause incoming light coming from a light source to be reflected, and rotate resulting reflected light, and includes a motor including a rotating portion arranged to rotate about a central axis extending in a vertical direction; and a flywheel supported by the rotating portion, and caused by the rotating portion to rotate about the central axis. The flywheel includes a lens arranged to allow the reflected light to pass therethrough; a lens frame arranged to be in contact with at least a portion of a peripheral portion of the lens; and a main body arranged to support the lens or the lens frame. The main body includes an outer cylindrical portion arranged to define at least a portion of an outer circumferential surface of the main body, and an accommodating portion in which the lens frame is arranged. At least a portion of the lens frame and at least a portion of the main body are arranged to have a first adhesion portion therebetween. At least a portion of the lens is arranged radially between the main body and the lens frame.

In the rotary drive apparatus according to one preferred embodiment of the present invention, the lens frame, which is arranged to be in contact with at least a portion of the peripheral portion of the lens, is fixed to the main body of the flywheel through adhesion. In addition, at least a portion of the lens is arranged radially between the main body of the flywheel and the lens frame. This reduces the likelihood that the lens, i.e., an optical component, will be detached from the rotary drive apparatus and come off or fly away due to aging.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a light source, a frame, and a rotary drive apparatus according to a first preferred embodiment of the present invention.

FIG. 2 is a vertical sectional view of the rotary drive apparatus according to the first preferred embodiment.

FIG. 3 is a perspective sectional view of a flywheel according to the first preferred embodiment.

FIG. 4 is a perspective sectional view of the flywheel according to the first preferred embodiment.

FIG. 5 is a perspective view of a mirror according to the first preferred embodiment.

FIG. 6 is a perspective sectional view of a main body of the flywheel according to the first preferred embodiment.

FIG. 7 is a perspective view of a lens according to the first preferred embodiment.

FIG. 8 is a perspective sectional view of a lens frame according to the first preferred embodiment.

FIG. 9 is a perspective sectional view of the lens and the main body of the flywheel according to the first preferred embodiment.

FIG. 10 is a partial perspective sectional view of the flywheel according to the first preferred embodiment.

FIG. 11 is a perspective sectional view of a lens frame according to a modification of the first preferred embodiment.

FIG. 12 is a partial perspective sectional view of a main body of a flywheel according to another modification of the first preferred embodiment.

### DETAILED DESCRIPTION OF THE PREFERRED EMBODIMENTS

Hereinafter, preferred embodiments of the present invention will be described with reference to the accompanying drawings. It is assumed herein that a direction parallel to a central axis of a motor, which will be described below, is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a light source is arranged with respect to the motor is defined as an upper side. The shape of each member or portion and relative positions of different members or portions will be described based on the above assumptions. It should be noted, however, that the above definitions of the vertical direction and the upper side are not meant to restrict in any way the orientation of a rotary drive apparatus according to any preferred embodiment of the present invention when in use. Also note that the term “parallel” as used herein includes both “parallel” and “substantially parallel”. Also note that the term “perpendicular” as used herein includes both “perpendicular” and “substantially perpendicular”.

### 1. First Preferred Embodiment

### 1-1. Structure of Rotary Drive Apparatus

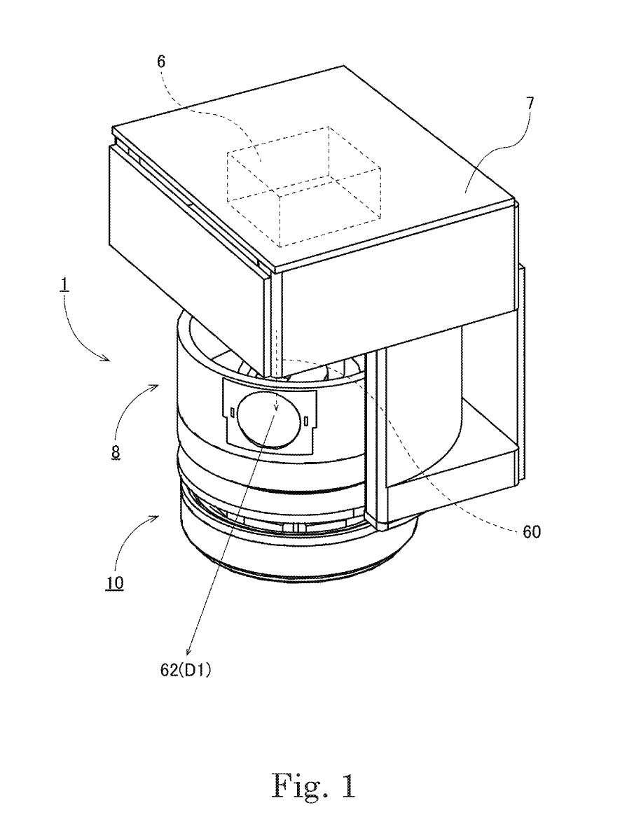

FIG. 1 is a perspective view of a light source 6, a frame 7, and a rotary drive apparatus 1 according to a first preferred embodiment of the present invention. The rotary drive apparatus 1 is an apparatus arranged to cause incoming light 60 coming from the light source 6 to be reflected in a radial direction (i.e., a first radial direction D1), and emit resulting reflected light 62 to an outside of the rotary drive apparatus 1 while rotating the reflected light 62. The frame 7, in which the light source 6 is installed, is arranged above the rotary drive apparatus 1. The frame 7 is fixed to a case or the like in which the rotary drive apparatus 1 is arranged. The incoming light 60, which travels downward along a central axis 9, which will be described below, of a motor 10, is emitted from the light source 6. In the present preferred embodiment, the light source 6 and the frame 7 are arranged outside of the rotary drive apparatus 1. Note, however, that each of the light source 6 and the frame 7 may alternatively be included in the rotary drive apparatus 1.

Referring to FIG. 1, the rotary drive apparatus 1 includes the motor 10 and a flywheel 8.

### 1-2. Structure of Motor

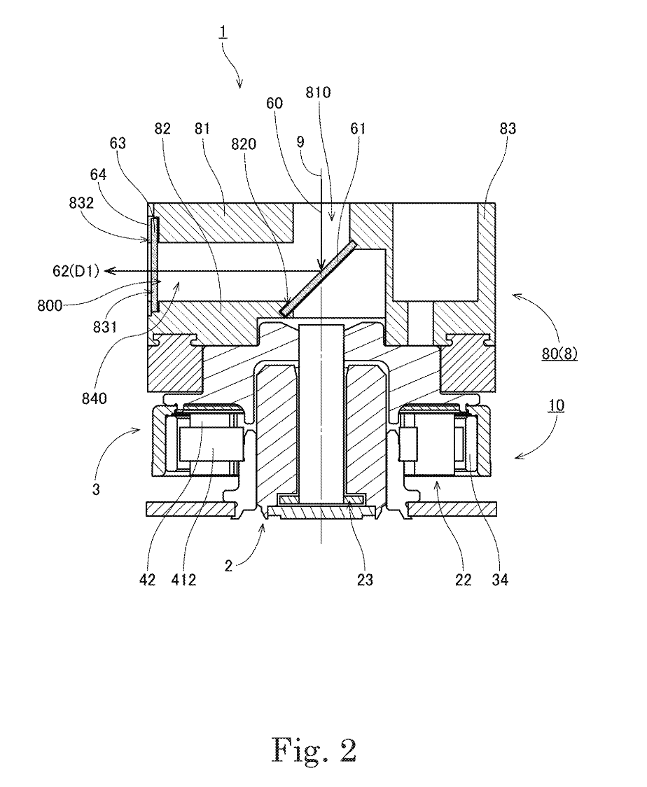

Next, the structure of the motor 10 will now be described below. FIG. 2 is a vertical sectional view of the rotary drive apparatus 1 according to the first preferred embodiment.

Referring to FIG. 2, the motor 10 includes a stationary portion 2 including a stator 22, and a rotating portion 3 including a magnet 34. The stationary portion 2 is arranged to be stationary relative to the frame 7. The rotating portion 3 is supported through a bearing portion 23 to be rotatable about the central axis 9, which extends in the vertical direction, with respect to the stationary portion 2.

Once electric drive currents are supplied to coils 42 included in the stationary portion 2, magnetic flux is generated around each of a plurality of teeth 412, which are magnetic cores for the coils 42. Then, interaction between the magnetic flux of the teeth 412 and magnetic flux of the magnet 34 included in the rotating portion 3 produces a circumferential torque between the stationary portion 2 and the rotating portion 3, so that the rotating portion 3 is caused to rotate about the central axis 9 with respect to the stationary portion 2. Thus, the flywheel 8, which is supported by the rotating portion 3 and which can be caused by the rotating portion 3 to rotate, is caused to rotate about the central axis 9 together with the rotating portion 3.

As the bearing portion 23, a fluid dynamic bearing, in which a portion of the stationary portion 2 and a portion of the rotating portion 3 are arranged opposite to each other with a gap in which a lubricating oil exists therebetween and which is arranged to induce a fluid dynamic pressure in the lubricating oil, is used, for example. Note that a bearing of another type, such as, for example, a rolling-element bearing, may alternatively be used as the bearing portion 23.

### 1-3. Structure of Flywheel

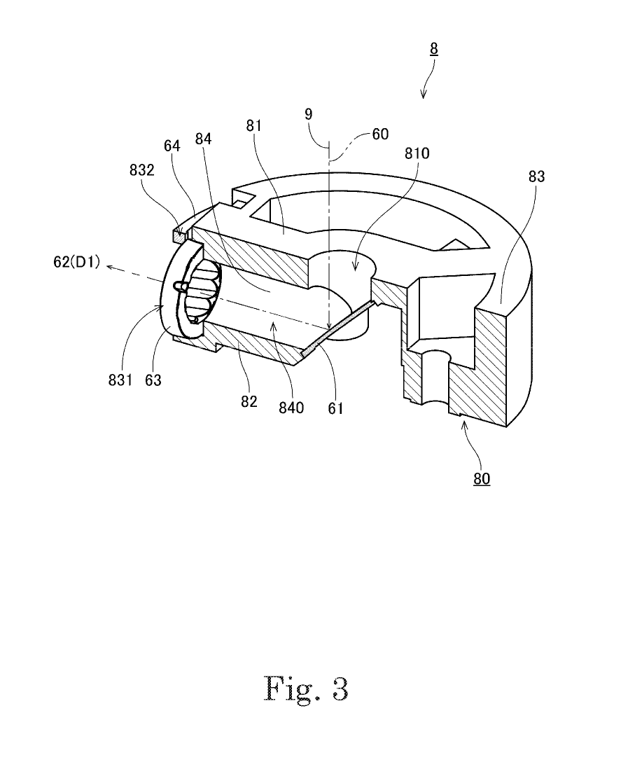

Next, the structure of the flywheel 8 will now be described below. Hereinafter, reference will be made to FIGS. 1 and 2 appropriately as well as FIGS. 3, 4, 5, 6, and 7, which will be described below.

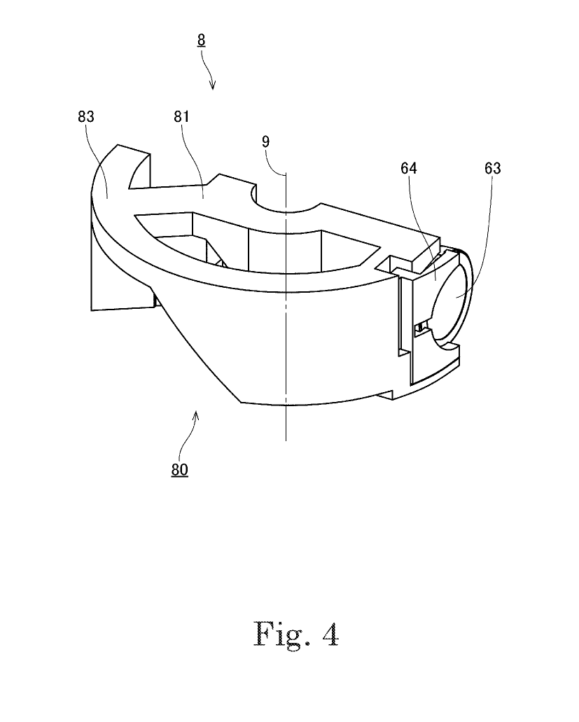

FIG. 3 is a perspective sectional view of the flywheel according to the first preferred embodiment. FIG. 4 is a perspective sectional view of the flywheel 8 according to the first preferred embodiment when viewed from a different direction. Each of FIGS. 3 and 4 is a perspective sectional view of a portion of the flywheel 8 which corresponds to a left half of the flywheel 8 when an outer circumferential surface of the flywheel 8 is viewed from outside with a lens 63 in a center. A portion of the flywheel which corresponds to a right half of the flywheel 8 has a structure similar to that of the portion of the flywheel 8 which corresponds to the left half thereof, and stands in symmetrical relation to the portion of the flywheel 8 which corresponds to the left half thereof. The flywheel 8 is arranged below the light source 6, and is supported by an upper end portion of the rotating portion 3 of the motor 10. The flywheel 8 is arranged to rotate about the central axis 9 together with the rotating portion 3. The flywheel 8 is fixed to an upper surface of the rotating portion 3 through, for example, engagement, an adhesive, or the like. Referring to FIGS. 3 and 4, the flywheel 8 includes a mirror 61, the lens 63, a lens frame 64, and a main body 80. In the present preferred embodiment, the main body 80 is arranged to support the lens frame 64, which is arranged to be in contact with at least a portion of a peripheral portion of the lens 63, and thus indirectly support the lens 63. Note, however, that the main body 80 may alternatively be arranged to directly support the lens 63.

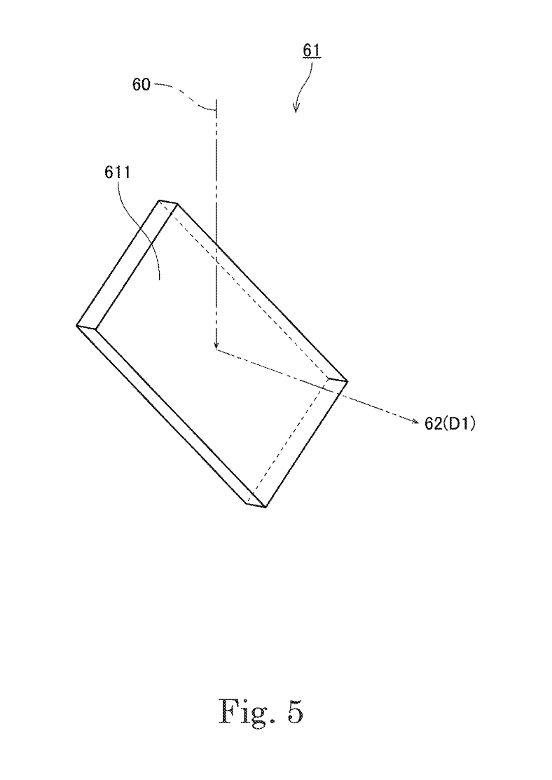

FIG. 5 is a perspective view of the mirror 61 according to the first preferred embodiment. Referring to FIG. 5, the mirror 61 is in the shape of a flat rectangular parallelepiped. In other words, the mirror 61 is in the shape of a rectangular plate. The mirror 61 is fixed to the main body 80 of the flywheel 8 with at least a portion of the mirror 61 arranged on the central axis 9. The mirror 61 is inclined at an angle of 45 degrees with respect to an axial direction and the first radial direction D1. In addition, the mirror 61 is held and fixed in a gap axially between an upper support portion 81 and a lower support portion 82, which will be described below, of the main body 80. The incoming light 60 impinges on a central portion of an upper surface 611, which is a reflecting surface, of the mirror 61. The central portion of the upper surface 611 refers to the entire upper surface 611, excluding a peripheral portion of the upper surface 611. A fully reflective mirror, for example, is used as the mirror 61. Glass is used as a material of the mirror 61. The material of the mirror is not limited to particular types of glass. For example, organic glass, inorganic glass, or the like, containing a resin, a metal, or other materials, may be used as the material of the mirror 61.

The main body 80 includes the upper support portion 81, the lower support portion 82, an outer cylindrical portion 83, and a horizontal cylindrical portion 84. A resin, for example, is used as a material of the main body 80. In the present preferred embodiment, the upper support portion 81, the lower support portion 82, the outer cylindrical portion 83, and the horizontal cylindrical portion 84 are defined as a single monolithic member by a resin injection molding process. Note, however, that the upper support portion 81, the lower support portion 82, the outer cylindrical portion 83, and the horizontal cylindrical portion 84 may alternatively be defined by separate members.

The upper support portion 81 is a portion of an upper portion of the main body 80, the portion lying inside of a peripheral portion of the upper portion of the main body 80. An upper surface of the upper support portion 81 defines at least a portion of an upper surface of the main body 80. The upper support portion 81 has a cavity 810 defined on and around the central axis 9 of the motor 10 on a radially inner side thereof. The cavity 810 is arranged to extend in parallel with the central axis 9. In addition, the cavity 810 is arranged to define a light path. At least a portion of a lower end portion of the upper support portion 81 is arranged to be in contact with at least a portion of the peripheral portion of the upper surface 611 of the mirror 61, in a state in which the mirror 61 is fixed to the flywheel 8. This contributes to more securely fixing the mirror 61.

The lower support portion 82 is a portion of a lower portion of the main body 80, the portion lying inside of a peripheral portion of the lower portion of the main body 80, and has at least a portion thereof arranged below the upper support portion 81. A lower surface of the lower support portion 82 defines at least a portion of a lower surface of the main body 80. The mirror 61 is held and fixed in a gap axially between the lower end portion of the upper support portion 81 and an upper end portion of the lower support portion 82. This contributes to more securely fixing the mirror 61. Note that the lower support portion 82 may alternatively be arranged to have a tubular structure and have a cavity defined radially inside thereof. Further, a portion of the incoming light 60 may be allowed to pass through the mirror 61, and this cavity may be arranged to define a light path along which the above portion of the incoming light 60 travels.

The outer cylindrical portion 83 is a cylindrical portion arranged to extend along the central axis 9 radially outside of the upper support portion 81 and the lower support portion 82. An outer circumferential surface of the outer cylindrical portion 83 defines at least a portion of an outer circumferential surface of the main body 80 of the flywheel 80. In addition, a lens accommodating portion 831, which is arranged to pass through the outer cylindrical portion 83 in the first radial direction D1, is defined in the outer cylindrical portion 83 at a circumferential position radially outside of a cavity 840 of the horizontal cylindrical portion 84, which will be described below. In addition, a frame accommodating portion 832, which is recessed radially inward from the outer circumferential surface of the outer cylindrical portion 83, is defined in the outer cylindrical portion 83 at a position radially outside of the lens accommodating portion 831. An inner circumferential surface of the outer cylindrical portion 83 is joined to each of a radially outer end portion of the upper support portion 81, a radially outer end portion of the lower support portion 82, and a radially outer end portion of the horizontal cylindrical portion 84, which will be described below. Thus, the outer cylindrical portion 83, the upper support portion 81, the lower support portion 82, and the horizontal cylindrical portion 84, which will be described below, are joined to one another.

The horizontal cylindrical portion 84 is a cylindrical portion arranged to extend outward in a radial direction (i.e., the first radial direction D1) from a position axially below the cavity 810 of the upper support portion 81. An upper portion of the horizontal cylindrical portion 84 is joined to the lower surface of the upper support portion 81. In addition, a lower portion of the horizontal cylindrical portion 84 is joined to an upper surface of the lower support portion 82. The lens 63 and the lens frame 64 are arranged radially outside of the horizontal cylindrical portion 84. The cavity 840 inside of the horizontal cylindrical portion 84 is joined to the cavity 810 of the upper support portion 81 at right angles. Further, the cavity 840 inside of the horizontal cylindrical portion 84, the mirror 61, and the lens 63 are arranged to overlap at least in part with one another when viewed in the first radial direction D1. The cavity 840 is arranged to define a light path. At least a portion of the lens 63 is arranged to cross a light path along which the reflected light 62 travels.

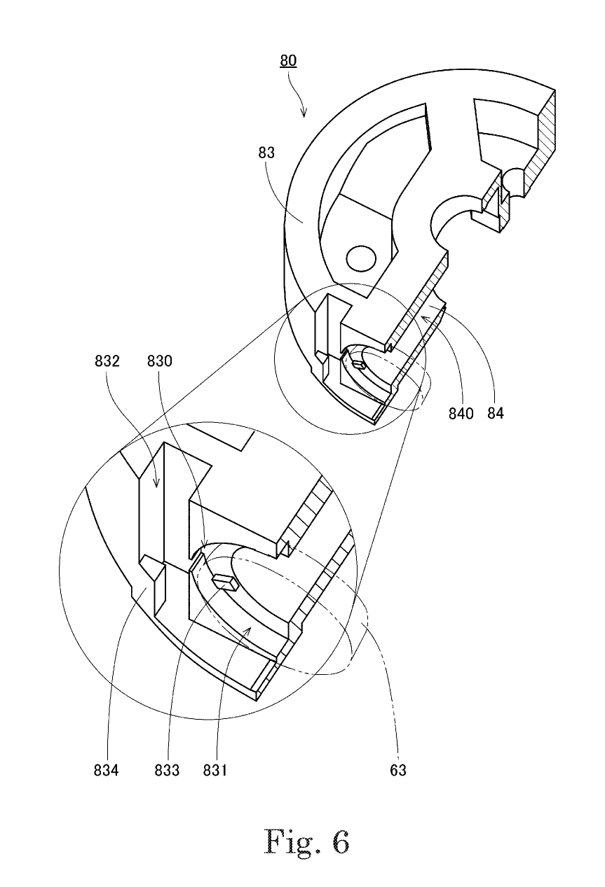

FIG. 6 is a perspective sectional view of the main body 80 of the flywheel 8 according to the first preferred embodiment. FIG. 6 is a perspective sectional view of a portion of the main body 80 which corresponds to a left half of the main body 80 when the outer circumferential surface of the main body 80 of the flywheel 8 is viewed from outside. A portion of the main body 80 which corresponds to a right half of the main body 80 has a structure similar to that of the portion of the main body 80 which corresponds to the left half thereof, and stands in symmetrical relation to the portion of the main body 80 which corresponds to the left half thereof. In FIG. 6, the lens 63 is represented by chain double-dashed lines. Referring to FIG. 6, the main body 80 further includes the lens accommodating portion 831, which is a disk-shaped space, defined in the outer cylindrical portion 83 at the circumferential position radially outside of the cavity 840 of the horizontal cylindrical portion 84. The lens accommodating portion 831 is arranged to cover an outer circumferential surface of the cavity 840 of the horizontal cylindrical portion 84. The lens 63 is arranged in the lens accommodating portion 831. The lens accommodating portion 831 is arranged below at least a portion of the main body 80 and above at least a portion of the main body 80. That is, each of a top portion and a bottom portion of the lens accommodating portion 831 is not exposed to an outside of the main body 80. This contributes to preventing the lens 63 from lifting from the lens accommodating portion 831 or from falling off the lens accommodating portion 831 in a state in which the lens 63 is accommodated in the lens accommodating portion 831.

The lens accommodating portion 831 is arranged to have a circumferential dimension greater than a circumferential dimension of the lens 63. That is, the lens accommodating portion 831 extends leftward beyond a left end portion of the lens 63 and rightward beyond a right end portion of the lens 63 when the outer circumferential surface of the flywheel 8 is viewed from outside with the lens 63 in the center. Thus, in the state in which the lens 63 is accommodated in the lens accommodating portion 831, a gap 830 is defined between the left end portion of the lens 63 and a left end portion of the lens accommodating portion 831, and between the right end portion of the lens 63 and a right end portion of the lens accommodating portion 831. In a state in which the lens frame 64 is accommodated in the frame accommodating portion 832, the gap 830 is surrounded by a surface of at least a portion of the lens 63, a surface of at least a portion of the lens frame 64, and at least a portion of the outer circumferential surface of the main body 80 on a radially outer side of the main body 80. In addition, at least a portion of the gap 830 is arranged to radially overlap with the lens frame 64.

As mentioned above, the main body 80 further includes the frame accommodating portion 832, which is recessed radially inward from the outer circumferential surface of the outer cylindrical portion 83, at the position radially outside of the lens accommodating portion 831. Specifically, the frame accommodating portion 832 is arranged to extend leftward beyond the left end portion of the lens accommodating portion 831 and rightward beyond the right end portion of the lens accommodating portion 831 when the outer circumferential surface of the flywheel 8 is viewed from outside with the lens 63 in the center. A top portion and an outer circumferential surface of the frame accommodating portion 832 are exposed to the outside of the main body 80. Further, the outer cylindrical portion 83 includes an engaging portion 834. A radially outer surface of the engaging portion 834 defines a portion of the outer circumferential surface of the flywheel 8. In addition, the engaging portion 834 is arranged radially outside of a lower portion of the frame accommodating portion 832. The engaging portion 834 and a structure for attaching the lens frame 64 to the main body 80 of the flywheel 8 will be described in detail below.

Further, the main body 80 includes one or more main body projecting portions 833 in a portion of the outer circumferential surface of the outer cylindrical portion 83, the portion facing the lens accommodating portion 831. Each main body projecting portion 833 is arranged to project in a radial direction toward the lens 63 accommodated in the lens accommodating portion 831. Each of the one or more main body projecting portions 833 is fitted in a corresponding one of one or more recessed portions 633, which will be described below, defined in the lens 63 in the state in which the lens 63 is accommodated in the lens accommodating portion 831. In other words, the lens 63 is arranged in the lens accommodating portion 831 such that each main body projecting portion 833 of the main body 80 is fitted in the corresponding recessed portion 633 of the lens 63. This enables the lens 63 to be attached, with high precision, to the main body 80 of the flywheel 8 at a desired circumferential position and at a desired angle with respect to the main body 80. In addition, the likelihood that a displacement or rotation of the lens 63 will occur after the lens 63 is arranged in the lens accommodating portion 831 is reduced.

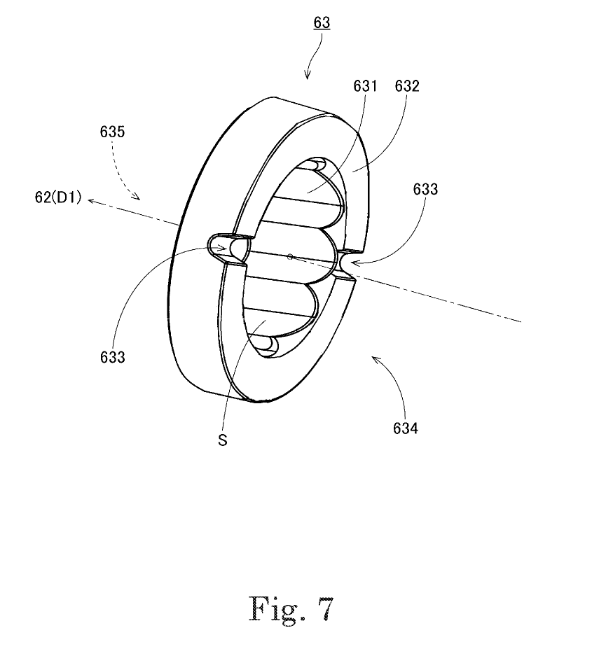

FIG. 7 is a perspective view of the lens 63 according to the first preferred embodiment. As illustrated in FIG. 7, the lens 63 is in the shape of a disk. The lens 63 is accommodated in the lens accommodating portion 831. In addition, the lens 63 is supported by the main body 80 of the flywheel 8 and the lens frame 64, which is arranged to be in contact with at least a portion of the peripheral portion of the lens 63. Further, the lens 63 is arranged at right angles to the first radial direction D1 in the lens accommodating portion 831. That is, the lens 63 is arranged in parallel with the central axis 9. An opening 800 at an outer end of the cavity 840 of the horizontal cylindrical portion 84 is covered with the lens 63. Glass is used as a material of the lens 63. The material of the lens 63 is not limited to particular types of glass. For example, organic glass, inorganic glass, or the like, containing a resin, a metal, or other materials, may be used as the material of the lens 63.

A surface of the lens 63 through which the reflected light 62, which is obtained by the mirror 61 reflecting the incoming light 60, enters the lens 63 and a surface of the lens 63 through which the reflected light 62, penetrating the lens 63, exits the lens 63 will be hereinafter referred to as a rear surface 634 and a front surface 635, respectively. Referring to FIG. 7, the lens 63 includes a penetrable portion 631 and an impenetrable portion 632. The penetrable portion 631 is a portion of the lens 63 which lies inside of the peripheral portion of the lens 63, and allows the reflected light 62 to pass therethrough. Meanwhile, the impenetrable portion 632 is a portion of the lens 63 which lies at the peripheral portion of the lens 63, and does not allow the reflected light 62 to pass therethrough. The penetrable portion 631 has a vertically-striped relief structure S in the rear surface 634 of the lens 63. The penetrable portion 631 is arranged to have an axial dimension smaller than an axial dimension of a lens attachment portion 642 of the lens frame 64, which will be described below.

The lens 63 includes the one or more recessed portions 633, each of which is recessed from the rear surface 634 toward the front surface 635 of the lens 63. In the present preferred embodiment, the one or more recessed portions 633 are arranged at regular intervals in the impenetrable portion 632 in the rear surface 634 of the lens 63. In the state in which the lens 63 is accommodated in the lens accommodating portion 831, the rear surface 634 is arranged opposite to a surface of the main body 80 of the flywheel 8, the surface including the aforementioned main body projecting portion(s) 833. As described above, when the lens 63 is accommodated in the lens accommodating portion 831, each of the one or more main body projecting portions 833 is fitted into the corresponding one of the one or more recessed portions 633.

Note that the lens may be arranged to have a specific penetration angle at which light easily passes through the lens. For example, the above-described lens 63 may be a lens that allows light to pass therethrough only at a specific penetration angle with an optical axis of the reflected light 62 as a center. In this case, the recessed portion(s) 633 of the lens 63 can be used to position the lens 63 at an angle in accordance with the penetration angle. For example, in the case where the penetration angle of the lens 63 is to be inclined at 45 degrees with respect to a direction in which the incoming light 60 travels with the optical axis of the reflected light 62 as the center, the lens 63 can be positioned at an appropriate angle using the recessed portion(s) 633.

The incoming light 60, which is emitted from the light source 6, enters the above-described flywheel 8 from above an upper surface of the flywheel 8, and travels downward along the central axis 9 in the cavity 810 radially inside of the upper support portion 81. Then, the incoming light 60 is reflected by the mirror 61 inside of the main body 80 of the flywheel 8 to become the reflected light 62. Thereafter, the reflected light 62 further travels outward in the first radial direction D1 in the cavity 840 inside of the horizontal cylindrical portion 84, and is emitted out of the rotary drive apparatus 1 through the lens 63.

The mirror 61 of the flywheel 8 is arranged to reflect the incoming light 60 from the light source 6 and emit the reflected light 62 to the outside while rotating about the central axis 9 together with the rotating portion 3 of the motor 10. Therefore, the first radial direction D1, which is a direction in which the reflected light 62 is emitted, also rotates together with the rotating portion 3. Thus, a wide range can be irradiated with light. Note that the rotation speed of the rotary drive apparatus 1 can be recognized by sensing rotation of the reflected light 62, which is emitted out of the flywheel 8, outside of the rotary drive apparatus 1. Further, when the rotary drive apparatus 1 is used in a scanner apparatus used for position recognition in a head-mounted display (HMD) or the like, position information concerning a target person can be obtained.

Note that the rotary drive apparatus 1 may further include, in addition to the flywheel 8 arranged to emit the reflected light 62 to the outside in the first radial direction D1, another flywheel (not shown) which is arranged to emit reflected light to the outside in a second radial direction different from the first radial direction D1, and which is arranged, for example, below the motor 10. In this case, a half mirror the transmissivity and reflectivity of which are substantially equal is used as the mirror 61. Then, a half of the incoming light 60 which impinges on the mirror 61 in the flywheel 8 is reflected in the first radial direction D1 to be emitted to the outside. In addition, a remaining half of the incoming light 60 which impinges on the mirror 61 is allowed to pass through the mirror 61 and travel further downward. Further, a through hole (not shown) passing through the motor 10 in the axial direction is defined around the central axis 9 in the motor 10. Thus, the portion of the incoming light 60 which has passed through the mirror 61 passes through the through hole and reaches the other flywheel arranged below the motor 10. Then, in the other flywheel, all the remaining half of the incoming light 60 is reflected in the second radial direction, using a fully reflective mirror (not shown), to be emitted to the outside. Note that the rotary drive apparatus 1 may alternatively include, above the flywheel 8, another flywheel (not shown) which includes a half mirror and is arranged to emit reflected light in the aforementioned second radial direction. Also note that a plurality of mirrors (not shown), including a half mirror, which are arranged to reflect the incoming light 60 in mutually different directions may alternatively be installed in the single flywheel 8.

When light is emitted out in the two different directions, i.e., the first radial direction D1 and the second radial direction, as described above, light beams that are emitted out in the two different directions take different times to reach an object to be irradiated with light while the motor 10 is rotating, and this makes it possible to precisely recognize the three-dimensional position of the object in a space. Note that the other flywheel may alternatively be arranged in a rotary drive apparatus (not shown) other than the rotary drive apparatus 1 including the flywheel 8.

### 1-4. Structure of Lens Frame and Structure for Attaching Lens Frame to Main Body of Flywheel

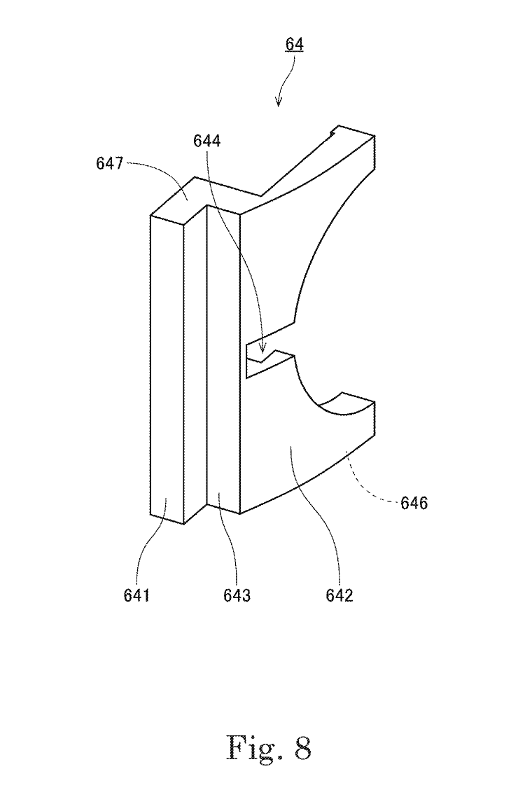

Next, the structure of the lens frame 64 and the structure for attaching the lens frame 64 to the main body 80 of the flywheel 8 will now be described in detail below. The following description will be made with reference to FIGS. 1 to 7 appropriately as well as FIGS. 8, 9, and 10, which will be described below.

FIG. 8 is a perspective sectional view of the lens frame according to the first preferred embodiment. FIG. 8 is a perspective sectional view of a portion of the lens frame 64 which corresponds to a left half of the lens frame 64 when the outer circumferential surface of the flywheel 8 is viewed from outside with the lens 63 in the center. A portion of the lens frame 64 which corresponds to a right half of the lens frame 64 has a structure similar to that of the portion of the lens frame 64 which corresponds to the left half thereof, and stands in symmetrical relation to the portion of the lens frame 64 which corresponds to the left half thereof. Referring to FIG. 8, the lens frame 64 includes a main body attachment portion 641, the lens attachment portion 642, and a joining portion 643. The main body attachment portion 641 is arranged most circumferentially outward in the lens frame 64. That is, the main body attachment portions 641 are portions of the lens frame 64 which are at left and right ends of the lens frame 64 when the outer circumferential surface of the flywheel 8 is viewed from outside. The lens attachment portion 642 is arranged in a circumferential middle of the lens frame 64. That is, the lens attachment portion 642 is a portion of the lens frame 64 which is in a middle of the lens frame 64 in a left-right direction when the outer circumferential surface of the flywheel 8 is viewed from outside. The joining portion 643 is arranged to extend in a radial direction to join the main body attachment portion 641 and the lens attachment portion 642 to each other. In the present preferred embodiment, the main body attachment portion 641 is arranged radially inward of at least a portion of the lens attachment portion 642. Note, however, that the main body attachment portion 641 may alternatively be arranged radially outward of the lens attachment portion 642.

The lens frame 64 further includes a frame penetration portion 644 in the form of a cut arranged to pass through the lens attachment portion 642 in the radial direction. The frame penetration portion 644 is arranged radially outside of at least a portion of the gap 830 in the state in which the lens frame 64 is accommodated in the frame accommodating portion 832.

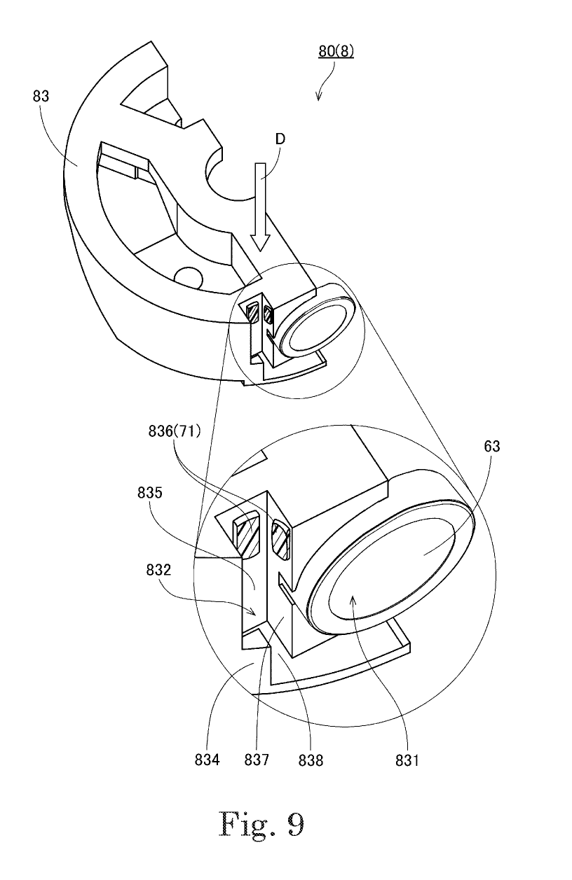

FIG. 9 is a perspective sectional view of the lens 63 and the main body 80 of the flywheel 8 according to the first preferred embodiment. FIG. 9 shows a perspective sectional view of the portion of the main body 80 which corresponds to the left half of the main body 80 when the outer circumferential surface of the flywheel 8 is viewed from outside with the lens 63 in the center. The portion of the main body 80 which corresponds to the right half of the main body 80 has a structure similar to that of the portion of the main body 80 which corresponds to the left half thereof, and stands in symmetrical relation to the portion of the main body 80 which corresponds to the left half thereof. Referring to FIG. 9, a first adhesive 836 is applied to a portion of the outer circumferential surface of the outer cylindrical portion 83 of the main body 80, the portion facing in the radial direction onto the frame accommodating portion 832. That is, the first adhesive 836 is applied to at least a portion of a first adhesion outer circumferential surface 835, which is a surface defining a portion of the frame accommodating portion 832 and lying radially inward. In addition, in the present preferred embodiment, the first adhesive 836 is additionally applied to a first adhesion side surface 837, which is a portion of the outer cylindrical portion 83 of the main body 80, the portion facing in a circumferential direction onto the frame accommodating portion 832. That is, the first adhesive 836 is also applied to the first adhesion side surface 837, which is a surface defining a portion of the frame accommodating portion 832 and lying on a circumferential side of a portion of the frame accommodating portion 832. Note that the application of the first adhesive 836 may be performed either after the lens 63 is accommodated in the lens accommodating portion 831, or before the lens 63 is accommodated in the lens accommodating portion 831.

After the first adhesive 836 is applied to each of the first adhesion outer circumferential surface 835 and the first adhesion side surface 837, the lens frame 64 illustrated in FIG. 8 is inserted into the frame accommodating portion 832 downwardly in a direction indicated by arrow D in FIG. 9 from above the main body 80 of the flywheel 8. The lens frame 64 is inserted thereinto until a lower surface 646 of the lens frame 64 is brought into contact with at least a portion of the main body 80, including a frame support surface 838 of the main body 80. Here, the frame support surface 838 is a surface defining a portion of the frame accommodating portion 832 and lying on a lower side. Thus, the likelihood that a coming off or flying away of the lens frame 64 will occur is reduced. Note that an upper surface 647 of the lens frame 64 is exposed to the outside of the main body 80 of the flywheel 8 even after the insertion of the lens frame 64 is completed.

In addition, while the lens frame 64 is inserted into the frame accommodating portion 832, the lens frame 64 makes contact with the first adhesive 836 applied to each of the first adhesion outer circumferential surface 835 and the first adhesion side surface 837. The first adhesive 836 spreads between the surface defining a portion of the frame accommodating portion 832 and at least a portion of the lens frame 64, including the main body attachment portion 641. Thus, a first adhesion portion 71 is defined between at least a portion of the lens frame 64, including the main body attachment portion 641, and at least a portion of the outer circumferential surface of the outer cylindrical portion 83 of the main body 80. As a result, the lens frame 64 is securely fixed to the main body 80 through the first adhesion portion 71.

Further, in the state in which the lens frame 64 is accommodated in the frame accommodating portion 832, at least a portion of the lens 63, including the impenetrable portion 632, is arranged radially between the outer circumferential surface of the main body 80 and a radially inner surface of the lens attachment portion 642 of the lens frame 64. The lens attachment portion 642 is arranged to radially hold the lens 63 with the lens 63 being held between the lens attachment portion 642 and the main body 80. In addition, the lens 63 is held between the joining portions 643 arranged on both circumferential sides of the lens 63. That is, when the outer circumferential surface of the flywheel 8 is viewed from outside with the lens 63 in the center, the lens 63 is arranged on the right side of a right end portion of the left joining portion 643 and on the left side of a left end portion of the right joining portion 643. The lens frame 64 is thus arranged to cover the lens 63 in the state in which the lens frame 64 is accommodated in the frame accommodating portion 832. The lens 63 is thus securely fixed in the lens accommodating portion 831. As a result, the likelihood that the lens 63 will be detached from the rotary drive apparatus 1 and come off or fly away due to aging is reduced.

In addition, in the state in which the lens frame 64 is accommodated in the frame accommodating portion 832, the engaging portion 834 is arranged radially outside of at least a portion of the main body attachment portion 641 of the lens frame 64. This reduces the likelihood that the lens frame 64 will be detached from the main body 80 and come off or fly away when a centrifugal force has been applied to the lens frame 64 by rotation of the flywheel 8. The engaging portion 834 is preferably arranged to have a sufficient axial dimension equal to or greater than about a quarter of a diameter of the lens 63.

In the state in which the lens frame 64 is accommodated in the frame accommodating portion 832, the lens frame 64 is arranged to radially overlap with only the impenetrable portion 632 of the lens 63. That is, the lens frame 64 does not radially overlap with the penetrable portion 631 of the lens 63. This reduces or prevents an influence of the reflected light 62 passing through the lens 63.

In addition, at least the lens attachment portion 642, which defines an abutting surface for the peripheral portion of the lens 63, of the lens frame 64 is arranged to be elastic. This contributes to reducing a load applied to the lens 63. This in turn contributes to preventing damage to the lens 63 even when the impenetrable portion 632, which is a portion of the lens 63 which radially overlaps with the lens attachment portion 642, has a relatively small thickness.

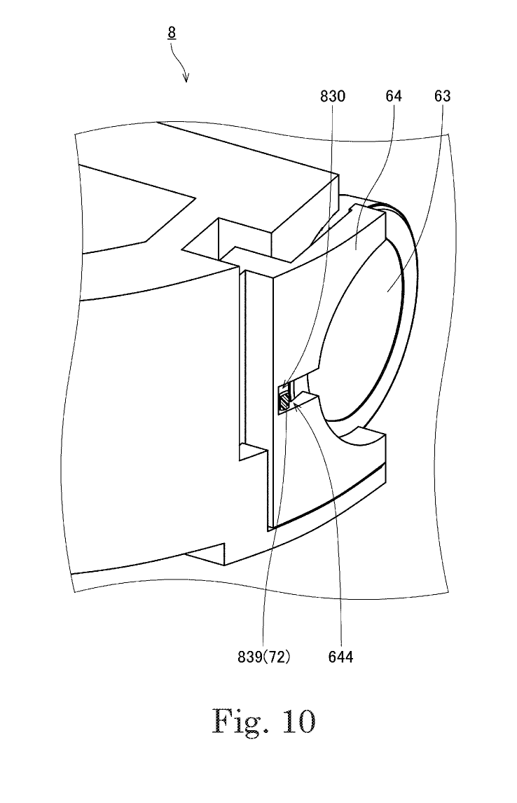

FIG. 10 is a partial perspective sectional view of the flywheel 8 according to the first preferred embodiment. FIG. 10 is a partial perspective sectional view of the portion of the flywheel 8 which corresponds to the left half of the flywheel 8 when the outer circumferential surface of the flywheel 8 is viewed from outside. The portion of the flywheel 8 which corresponds to the right half of the flywheel 8 has a structure similar to that of the portion of the flywheel 8 which corresponds to the left half thereof, and stands in symmetrical relation to the portion of the flywheel 8 which corresponds to the left half thereof. Referring to FIG. 10, in the state in which the lens frame 64 is accommodated in the frame accommodating portion 832, a second adhesive 839 is applied into the gap 830 through the frame penetration portion 644 from radially outside of the lens frame 64. Thus, a second adhesion portion 72 is defined in the gap 830, the second adhesion portion 72 being in contact with the surface of the at least a portion of the lens 63, the surface of the at least a portion of the lens frame 64, and the at least a portion of the outer circumferential surface of the main body 80. As a result, the lens 63 and the lens frame 64 can be more securely fixed to the main body 80. In addition, the likelihood that the lens 63 and the lens frame 64 will be detached from the rotary drive apparatus 1 and come off or fly away due to aging can be further reduced.

### 2. Example Modifications

While preferred embodiments of the present invention have been described above, it will be understood that the present invention is not limited to the above-described preferred embodiments.

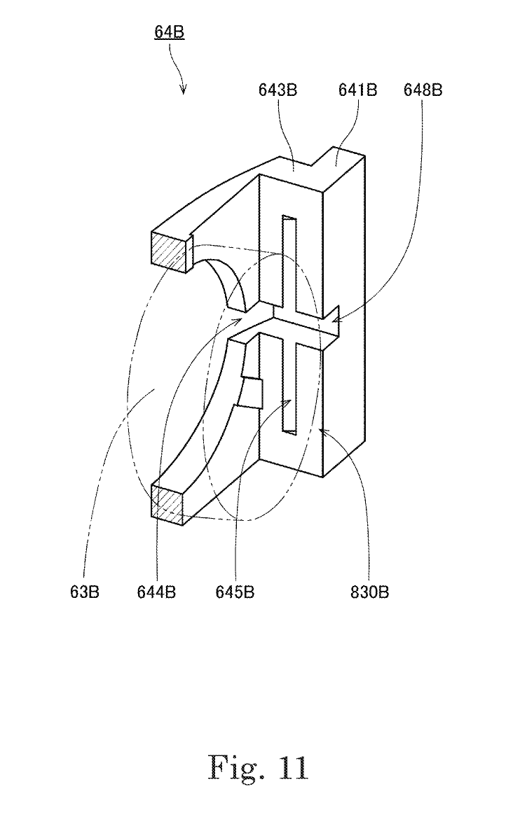

FIG. 11 is a perspective sectional view of a lens frame 64B according to a modification of the first preferred embodiment. FIG. 11 is a perspective sectional view of a portion of the lens frame 64B which corresponds to a left half of the lens frame 64B when an outer circumferential surface of a flywheel (not shown) is viewed from outside with a lens 63B in the center. A portion of the lens frame 64B which corresponds to a right half of the lens frame 64B has a structure similar to that of the portion of the lens frame 64B which corresponds to the left half thereof, and stands in symmetrical relation to the portion of the lens frame 64B which corresponds to the left half thereof. In FIG. 11, the lens 63B is represented by chain double-dashed lines. Referring to FIG. 11, the lens frame 64B further includes a frame groove portion 645B recessed in a joining portion 643B. In the joining portion 643B, the frame groove portion 645B is arranged to be in communication with a gap 830B defined circumferentially between the lens 63B and the lens frame 64B, and to be recessed in a direction away from the gap 830B. When a second adhesive (not shown) is applied into the gap 830B through a frame penetration portion 644B from radially outside of the lens frame 64B, the second adhesive (not shown) reaches into the frame groove portion 645B. Thus, the lens 63B and the lens frame 64B can be more securely fixed to a main body 80B of the flywheel. Note that the number of frame groove portions 645B may be one or more than one.

In addition, the lens frame 64B may further include a frame main body groove portion 648B recessed in a main body attachment portion 641B. In the present modification, the frame main body groove portion 648B is arranged to be in communication with the gap 830B in the main body attachment portion 641B, and to define a gap between the lens frame 64B and the main body (not shown) of the flywheel. Thus, when the second adhesive (not shown) is applied into the gap 830B, the second adhesive (not shown) reaches into the frame main body groove portion 648B. As a result, the lens 63B and the lens frame 64B can be more securely fixed to the main body (not shown).

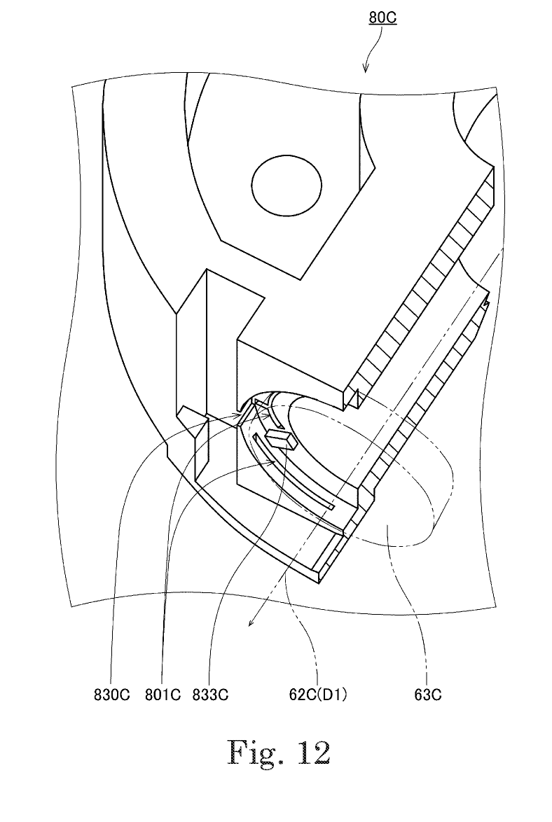

FIG. 12 is a partial perspective sectional view of a main body 80C of a flywheel according to another modification of the first preferred embodiment. FIG. 12 is a partial perspective sectional view of a portion of the main body 80C of the flywheel which corresponds to a left half of the main body 80C when an outer circumferential surface of the main body 80C is viewed from outside. A portion of the main body 80C which corresponds to a right half of the main body 80C has a structure similar to that of the portion of the main body 80C which corresponds to the left half thereof, and stands in symmetrical relation to the portion of the main body 80C which corresponds to the left half thereof. In FIG. 12, a lens 63C is represented by chain double-dashed lines. Referring to FIG. 12, the main body 80C further includes a main body groove portion 801C recessed at a position radially inside of the lens 63C or a lens frame (not shown). The main body groove portion 801C is arranged to be in communication with a gap 830C defined between the main body 80C and the lens 63C, and to be recessed in a direction away from the gap 830C. When a second adhesive (not shown) is applied into the gap 830C, the second adhesive (not shown) reaches into the main body groove portion 801C. Thus, the lens 63C or the lens frame can be more securely fixed to the main body 80C.

In the case where an adhesive having a low viscosity is used as the second adhesive (not shown), the main body groove portion 801C defined in the main body 80C is able to guide a flow of the second adhesive (not shown). This contributes to preventing the second adhesive (not shown) from flowing onto a penetrable portion of the lens 63C. In addition, a position at which the lens 63C is fixed to the main body 80C of the flywheel can be adjusted by changing a position at which the main body groove portion 801C is defined.

Note that the main body groove portion 801C may be arranged to be recessed in a surface of the main body 80C which is opposite to the lens 63C in directions perpendicular to a first radial direction D1, in which a reflected light 62C travels. Also note that the number of main body groove portions 801C may be one or more than one.

The main body 80C includes one or more main body projecting portions 833C each of which is arranged to project toward the lens 63C, and each main body projecting portion 833C is arranged to be fitted into a corresponding one of one or more recessed portions defined in the lens 63C and recessed from a rear surface toward a front surface of the lens 63C. Here, each main body projecting portion 833C is preferably arranged not to overlap with any main body groove portion 801C in a radial direction or a circumferential direction.

In addition, in the lens 63C, a position or positions radially opposed to the main body projecting portion(s) 833C and a position or positions radially opposed to the main body groove portion(s) 801C are preferably arranged at regular intervals in a peripheral portion of the lens 63C. This will make it easier to set the positions of the main body projecting portion(s) 833C and the main body groove portion(s) 801C when the flywheel is manufactured.

In the above-described preferred embodiment, the lens frame 64 includes the main body attachment portions 641, the lens attachment portion 642, and the joining portions 643. Note, however, that the lens frame 64 may alternatively include only the lens attachment portion 642 and the joining portion(s) 643. In this case, each joining portion 643 may be fixed to the main body 80 of the flywheel 8 to hold the lens 63.

In the first and second modifications described above, the frame groove portion 645B and the main body groove portion 801C, respectively, into which the second adhesive is applied, are provided. Note, however, that, instead of defining such a groove portion, a portion of the lens frame 64 or the main body 80 may be cut off to define a cut in the lens frame 64 or the main body 80 to define a gap in which the second adhesive is to be held.

In the above-described preferred embodiment, an adhesive having a low viscosity is used as the second adhesive 839. Note, however, that an adhesive having a high viscosity may alternatively be used as the second adhesive 839. This will contribute to preventing the second adhesive 839 from flowing onto the penetrable portion 631 of the lens 63. In addition, even in the case where an adhesive having a high viscosity is used as the second adhesive 839, the second adhesive 839 can be sufficiently retained with a groove portion or a cut being defined in the lens frame 64 or the main body 80.

In the above-described preferred embodiment, the plurality of recessed portions 633 are arranged at regular intervals in the impenetrable portion 632, which lies at the peripheral portion of the lens 63, in the rear surface 634 of the lens 63. Note, however, that the recessed portions 633 may alternatively be arranged at irregular intervals.

Also note that the detailed shape of any member may be different from the shape thereof as illustrated in the accompanying drawings of the present application. Also note that features of the above-described preferred embodiments and the modifications thereof may be combined appropriately as long as no conflict arises.

Preferred embodiments of the present invention are applicable to, for example, rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary drive apparatus arranged to cause incoming light coming from a light source to be reflected, and rotate resulting reflected light, the rotary drive apparatus comprising:
a motor including a rotating portion arranged to rotate about a central axis extending in a vertical direction; and
a flywheel supported by the rotating portion, and caused by the rotating portion to rotate about the central axis; wherein the flywheel includes:
a lens arranged to allow the reflected light to pass therethrough;
a lens frame arranged to be in contact with at least a portion of a peripheral portion of the lens; and
a main body arranged to support the lens or the lens frame;
the main body includes:
an outer cylindrical portion arranged to define at least a portion of an outer circumferential surface of the main body; and
an accommodating portion in which the lens frame is arranged;
at least a portion of the lens frame and at least a portion of the main body are arranged to have a first adhesion portion therebetween; and
at least a portion of the lens is arranged radially between the main body and the lens frame.

2. The rotary drive apparatus according to claim 1, wherein the first adhesion portion is arranged between at least a portion of the lens frame and at least a portion of an outer circumferential surface of the outer cylindrical portion.

3. The rotary drive apparatus according to claim 1, wherein
the flywheel includes, on a radially outer side of the main body, a gap surrounded by a surface of at least a portion of the lens, a surface of at least a portion of the lens frame, and at least a portion of the outer circumferential surface of the main body; and
the flywheel includes a second adhesion portion arranged to be in contact with the surface of the at least a portion of the lens, the surface of the at least a portion of the lens frame, and the at least a portion of the outer circumferential surface of the main body in the gap.

4. The rotary drive apparatus according to claim 1, wherein
the main body further includes one or more projecting portions each of which is arranged to project toward the lens;
the lens further includes one or more recessed portions each of which is recessed from a rear surface toward a front surface of the lens; and
each projecting portion is arranged to be fitted into the corresponding recessed portion.

5. The rotary drive apparatus according to claim 1, wherein
the lens includes:
a penetrable portion arranged to allow the reflected light to pass therethrough; and
an impenetrable portion arranged at the peripheral portion of the lens, and arranged not to allow the reflected light to pass therethrough;
the lens frame includes:
a main body attachment portion fixed to the main body through the first adhesion portion;
a lens attachment portion arranged to radially hold the lens; and
a joining portion arranged to join the main body attachment portion and the lens attachment portion to each other; and
at least a portion of the impenetrable portion is arranged radially between the outer circumferential surface of the main body and the lens attachment portion.

6. The rotary drive apparatus according to claim 5, wherein the lens frame is arranged to radially overlap with only the impenetrable portion.

7. The rotary drive apparatus according to claim 5, wherein the main body attachment portion is arranged radially inward of the lens attachment portion.

8. The rotary drive apparatus according to claim 5, wherein the penetrable portion is arranged to have an axial dimension smaller than an axial dimension of the lens attachment portion.

9. The rotary drive apparatus according to claim 5, wherein the lens is held between two of the joining portions arranged on both circumferential sides of the lens.

10. The rotary drive apparatus according to claim 5, wherein at least the lens attachment portion of the lens frame is arranged to be elastic.

11. The rotary drive apparatus according to claim 5, wherein
the outer cylindrical portion of the main body includes an engaging portion; and
the engaging portion is arranged radially outside of at least a portion of the main body attachment portion.

12. The rotary drive apparatus according to claim 11, wherein the engaging portion is arranged to have an axial dimension equal to or greater than a quarter of a diameter of the lens.

13. The rotary drive apparatus according to claim 1, wherein the lens frame includes an upper surface exposed to an outside of the flywheel.

14. The rotary drive apparatus according to claim 3, wherein
the lens frame includes:
a main body attachment portion fixed to the main body through the first adhesion portion;
a lens attachment portion arranged to radially hold the lens; and
a joining portion arranged to join the main body attachment portion and the lens attachment portion to each other; and
the lens frame further includes one or more frame groove portions each of which is arranged to be in communication with the gap, and to be recessed in the joining portion or the main body attachment portion.

15. The rotary drive apparatus according to claim 3, wherein the main body further includes one or more main body groove portions each of which is arranged to be in communication with the gap, and to be recessed at a position radially inside of the lens or the lens frame.

16. The rotary drive apparatus according to claim 15, wherein
the main body further includes one or more projecting portions each of which is arranged to project toward the lens;
the lens further includes one or more recessed portions each of which is recessed from a rear surface toward a front surface of the lens;
each projecting portion is arranged to be fitted into the corresponding recessed portion; and
each projecting portion is arranged not to overlap with any main body groove portion in a radial direction or a circumferential direction.

17. The rotary drive apparatus according to claim 16, wherein in the lens, a position or positions radially opposed to the one or more projecting portions and a position or positions radially opposed to the one or more main body groove portions are arranged at regular intervals in the peripheral portion of the lens.
